(19) United States
(12) Patent Application Publication
(10) Pub. No.: US 2010/0211663 A1
(43) Pub. Date: Aug. 19, 2010

(54) MANAGEMENT OF POOL MEMBER CONFIGURATION

(75) Inventors: Dmitry Barboy, Rishon Le Zion (IL); Anatoly Kardash, Rishon Le Zion (IL); Roman Listiev, Rehovot (IL); Mikhail Iavnilovitch, Rehovot (IL); Leonid Shtilman, Lexington, MA (US)

Correspondence Address: OCCHIUTI ROHLICEK & TSAO, LLP, 10 FAWCETT STREET, CAMBRIDGE, MA, 02138, US

(73) Assignee: Viewfinity Inc., Waltham, MA (US)

(21) Appl. No.: 12/684,727

(22) Filed: Jan. 8, 2010

Related U.S. Application Data
(63) Continuation-in-part of application No. 12/180,749, filed on Jul. 28, 2008.

(51) Int. Cl. G06F 15/173

(52) U.S. Cl. 709/223; 726/28

(57) ABSTRACT

A system for providing virtual desktop images to users of pool members from a pool includes a server subsystem in data communication with a plurality of pool members, said server subsystem being configured to receive, from a user, a request to log into a first pool member from said pool; to retrieve a virtual desktop image for use by said first pool member; to inspect a user policy corresponding to said user; to modify said virtual desktop image consistently with said user policy; and to provide said virtual desktop to said first pool member.

### CROSS-REFERENCE TO RELATED APPLICATIONS

This application is a continuation-in-part of U.S. application Ser. No. 12/180,749, filed on Jul. 28, 2008, the contents of which are hereby incorporated by reference in their entirety.

### BACKGROUND

This disclosure relates to pools of computing devices, and in particular, to managing persistency associated with individual users who use pool members within such a pool.

A large organization often includes a pool of desktop computers, each of which is referred to herein as a “pool member.” An employee logs into one of these pool members upon coming to work. However, there is no guarantee that a particular employee will always log into the same pool member.

An organization's Information Technology (IT) infrastructure may support various levels of computing devices. At an enterprise level, the organization's IT infrastructure may support server computing devices having dedicated functionality, such as web servers, print servers, and database servers. At an end user level, the organization's IT infrastructure may support physical user computing devices (e.g., desktop computers, laptops, net-books, tablets, and handheld computers) and virtual user computing devices (e.g., virtual machines executing on a shared server computing device).

In this description, the term “pool member” refers generally to any user computing device (physical or virtual) operable by an end user (e.g., an employee of the organization) within the organization's IT infrastructure. In some cases, a pool member is a standard-issue physical computing device that is equipped with a suite of programs that have been installed and configured to run in some standard way. In other cases, a pool member refers to a virtual computing device that may be instantiated and destroyed, at will, for instance, before and after user sessions. In other cases, a pool member is a physical or virtual computing device created from a shared master image and a particular user's personal data files. In yet other cases, the combination of a thin client and its corresponding virtual machine computing device may be referred to collectively as a “pool member.”

The pool members usually interact, through a network, with each other and/or with one or more server computing devices. Each pool member is said to conform to a “baseline image,” which can be instantiated locally in a physical user computing device or in a virtual user computing device at a remote server. The use of a uniform “baseline image” considerably simplifies software maintenance and troubleshooting tasks. A pool in which each pool member maintains the same baseline image is said to be a “homogeneous pool.”

Different employees may have different job functions, which in turn require access to different applications and data. For example, a customer service employee may have access to customer account data that would not be available to a technical support employee. Conversely, the technical support employee may have access to all earlier versions of a software application he is charged with supporting, so that he can better recreate a caller's experience.

It is apparent therefore that different users will have different software requirements. However, since each pool member executes the same baseline image, there exist some difficulties associated with ensuring that different users have access to only the applications they require.

In the course of using a particular pool member, a first user may make certain changes to their environment. In some cases, these changes are saved, so that a second user who logs into the same physical pool member will experience the effects of these changes. In such a case, the changes made by the first user are said to be “persistent.” In other cases, these changes are discarded when the first user logs off. Such changes made by the first user are said to be “non-persistent.”

Persistent changes can result in changes to the baseline image executed by a particular pool member. When this occurs, the images of all pool members in the pool will no longer be uniform. As a result, the pool is no longer a “homogeneous” pool. Instead, it becomes a “heterogeneous” pool.

For those entrusted with software maintenance and troubleshooting, heterogeneous pools are more troublesome. In an effort to maintain homogeneity of a pool, it is known to cause any user changes to be non-persistent. In such cases, any changes the user makes are undone when the user logs off. This results in a pool of computers that remains homogenous, and that is therefore easier to maintain.

On the other hand, there may be cases in which some user changes should be made persistent. It is therefore desirable to enable some user changes to be persistent without imposing unnecessary difficulties in software maintenance that may arise from having an inhomogeneous pool of desktop computers.

Difficulties in maintenance often arise because modern computer operating systems include complex file system schemas. For example, the various incarnations of Microsoft Windows use a file folder approach including special folder names contextually associated with various other folders, for example through the use of environment variables. Some operating systems also use configuration databases. For example, most variants of Microsoft Windows use a registry for additional data, including configuration specifics. Applications make varying use of the available file system schema. When multiple applications are installed in a single computing environment, the file system usage between applications can overlap. This leads to conflicts and unexpected overwrites.

In a simple installation of an application, a single executable file is placed in the file system. No additional provisioning is required. In a more complex installation, additional files may need to be placed in the file system, and other configuration and provisioning steps may be required. For example, some executable files, when executed, load additional files into operational memory (e.g., dynamic link libraries, or “DLL”s). Some of these libraries may be included with the operating system and commonly shared across installations. Other libraries may be custom libraries written for the application and included with the executable file. An executable that uses a large amount of static data, for example a language dictionary or a collection of graphics, may use additional data files separate from the executable file. Some executable files may invoke additional executable files, for example to handle background tasks or provide nested support. An installation process may also create new files. For example, a process might create files containing customization information or a file directory address for the proper executable along with any operation flags and configuration metadata. One example of this is the Microsoft Windows Shortcut. The installation may cause the shortcut file to be placed in a shared location, for example a directory of shortcuts for display to the user on a menu. There are many additional types of files that may also be included in an installation.

Complex application installations can include a large number of files written to a variety of different locations. Some of the locations may be shared with other installations. This raises the possibility that a file might be overwritten by another installation. In addition to file placement, installation may also modify operating system tables and databases, for example by placing information in the Microsoft Windows Registry. In some applications the installation and provisioning process is scripted, for example using the Microsoft Windows Installer (“MSI”), which relies on installation packages to know where to place files and update the registry. The MSI installation data also includes information for uninstalling the package; this information is also stored by the operating system. The Windows Installer presents an imperfect approach. Not every application uses the system. Once an application is installed it can be de-synchronized from the uninstall information if, for example, a user moves files manually.

### SUMMARY

In one aspect, the invention features a system for providing virtual desktop images to users of pool members from a pool. Such a system includes a server subsystem in data communication with a plurality of pool members. The server subsystem is configured to receive, from a user, a request to log into a first pool member from a pool; to retrieve a virtual desktop image for use by the first pool member; to inspect a user policy corresponding to the user; to modify the virtual desktop image consistently with the user policy; and to provide the virtual desktop to the first pool member.

In another aspect, the invention features a computer-implemented method that is tied to a particular computer system so as to cause that computer system to provide virtual desktop images to users of pool members. The computer-implemented method includes receiving, from a user, a request to log into a first pool member from a pool, retrieving a virtual desktop image for use by the first pool member; inspecting a user policy; modifying the virtual desktop image consistently with the user policy; and providing the virtual desktop to the first pool member;

In some alternative practices, the method also includes receiving, from the user, a request to log into a second pool member. This second pool member is different from the first pool member. The method further includes retrieving the virtual desktop image for use by the second pool member; inspecting the user policy; modifying the virtual desktop consistently with the user policy; and providing the virtual desktop to the second pool member.

Other alternative practices include those in which modifying the virtual desktop includes denying the user access to an application on the basis of various reasons. Exemplary reasons include a time of log-in, a location from which log-in is attempted, and the user's identity.

Yet other alternative practices include those in which modifying the virtual desktop includes incorporating selected changes made by the user in a preceding session. The preceding session could have taken place on the same pool member that the user is currently using, or on a pool member that differs from the pool member that the user is currently using.

Other practices include implementing a persistency policy in which certain user changes are deemed persistent and certain other user changes are deemed non-persistent.

Still other practices include those in which modifying the virtual desktop image includes encapsulating selected applications available in the image.

Among the practices of the invention are those that include storing, at a remote data storage system, a plurality of user dossiers, each of which includes metadata representative of configuration changes made by a user to a virtual desktop image.

In another aspect, the invention features a manufacture including a computer-implemented medium having encoded thereon software for causing a computer system to provide virtual desktop images to users of pool members, the software including computer-executable instructions for receiving, from a user, a request to log into a first pool member from a pool; retrieving a virtual desktop image for use by the first pool member; inspecting a user policy; modifying the virtual desktop image consistently with the user policy; and providing the virtual desktop to the first pool member.

In some alternative embodiments, the software encoded on the manufacture also includes instructions for receiving, from the user, a request to log into a second pool member. This second pool member is different from the first pool member. The manufacture further includes retrieving the virtual desktop image for use by the second pool member; inspecting the user policy; modifying the virtual desktop consistently with the user policy; and providing the virtual desktop to the second pool member.

Other embodiments include those in which the instructions for modifying the virtual desktop include instructions for denying the user access to an application on the basis of various reasons. Exemplary reasons include a time of log-in, a location from which log-in is attempted, and the user's identity.

Yet other embodiments include those in which the instructions for modifying the virtual desktop include instructions for incorporating selected changes made by the user in a preceding session. The preceding session could have taken place on the same pool member that the user is currently using, or on a pool member that differs from the pool member that the user is currently using.

Other embodiments include those in which the software includes instructions for implementing a persistency policy in which certain user changes are deemed persistent and certain other user changes are deemed non-persistent.

Still other embodiments include those in which the instructions for modifying the virtual desktop image includes instructions for encapsulating selected applications available in the image.

Among the embodiments of the invention are those in which the software encoded on the manufacture includes instructions for storing, at a remote data storage system, a plurality of user dossiers, each of which includes metadata representative of configuration changes made by a user to a virtual desktop image.

Other features and advantages of the invention are apparent from the following description, and from the claims.

### DESCRIPTION OF DRAWINGS

FIG. 1 is a diagram of pool members connected to a server computing device;

FIG. 2 is a diagram showing implementation of user-specific policies for users logged into pool members of FIG. 1;

FIG. 3 is a block diagram of run-time software executing on a pool member from the pool shown in FIG. 1;

FIG. 4 is a line diagram of a file system hierarchy tree;

FIG. 5 is a block diagram showing exemplary views from a capsule for a particular file distribution;

FIG. 6 is a set of line diagrams of a file system hierarchy tree;

FIG. 7 is a flow chart showing processing steps following interception of a file or registry request; and

FIG. 8 is a diagram of plural servers connected to a pool member.

### DESCRIPTION

One computer-implemented method for managing configuration of one or more particular pool members in a pool of user computing devices is to manage on the basis of the user's identity. Such a method, which is tied to one or more particular pool members or to a particular server computing device, includes controlling what applications can be seen or used by a particular user, as well as controlling what changes made by that user are to be deemed persistent.

Such configuration control can be carried out by maintaining, for each user, an association between the various elements of an application or software suite selectively deployed to a pool member, as well as information concerning selected changes made by a user. Such elements include executable files, DLLs, configuration files, registry entries, user generated files, and any other file or system state used by the application. The aggregation of application elements, managed as a whole, is referred to in this description as a “capsule”. The process of aggregating the application elements is referred to in this description as “application encapsulation,” or simply “encapsulation,” with the resulting state referred to as an “encapsulated application.” In some cases multiple applications are managed as a single capsule.

One result of such encapsulation is the separation between applications, configurations and user changes on the one hand, and the underlying operating system. The separation enables a particular user's virtual desktop to be reconstructed “on the fly” at a particular pool member when a particular user begins using that pool member in a user session by beginning with a baseline image and masking selected portions of that baseline image according to factors including the identity of the user. This results in only selected applications and data being accessible by the user. These permitted applications and data are deemed “persistent” parts of a user's configuration, whereas other applications and data that are not available in the reconstructed image are deemed “non-persistent.”

The selection of which applications, settings, and data files are persistent and which are non-persistent is stored in a user policy for that user. A level of persistency represented in a user policy can span the gamut between total persistence, in which all configuration changes carried out by the user during a session persist following that session, and total non-persistence, in which none of the changes carried out by a user during a particular session persist beyond that session, and partial persistence, in which selected applications and data are retained while others are concealed or discarded. Partial persistence policies can include those in which selected applications are available only at selected times or only from selected locations.

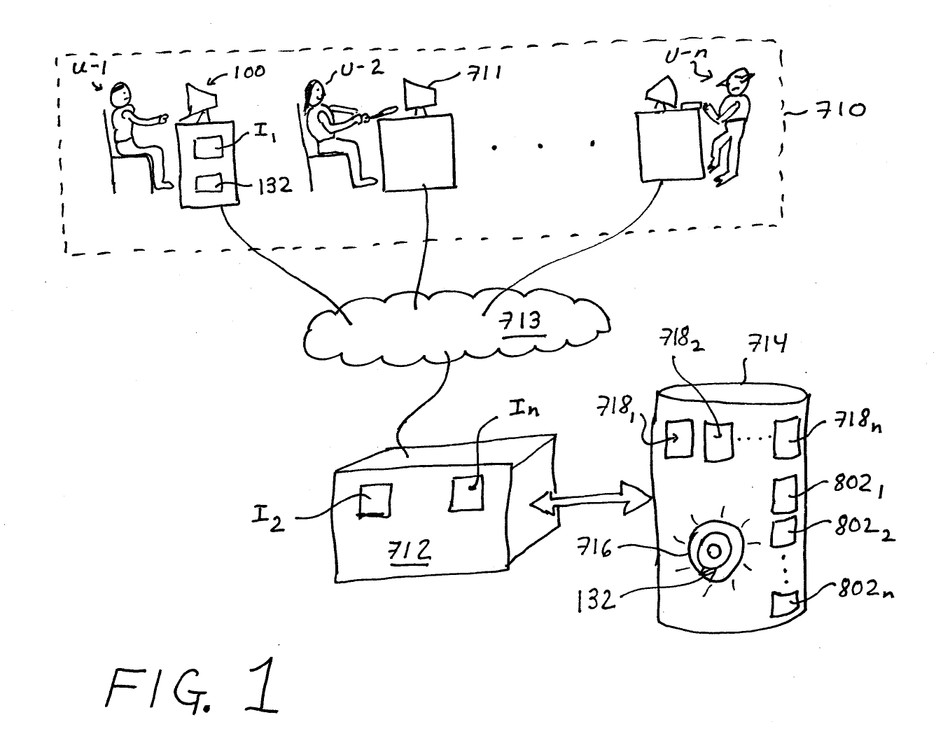

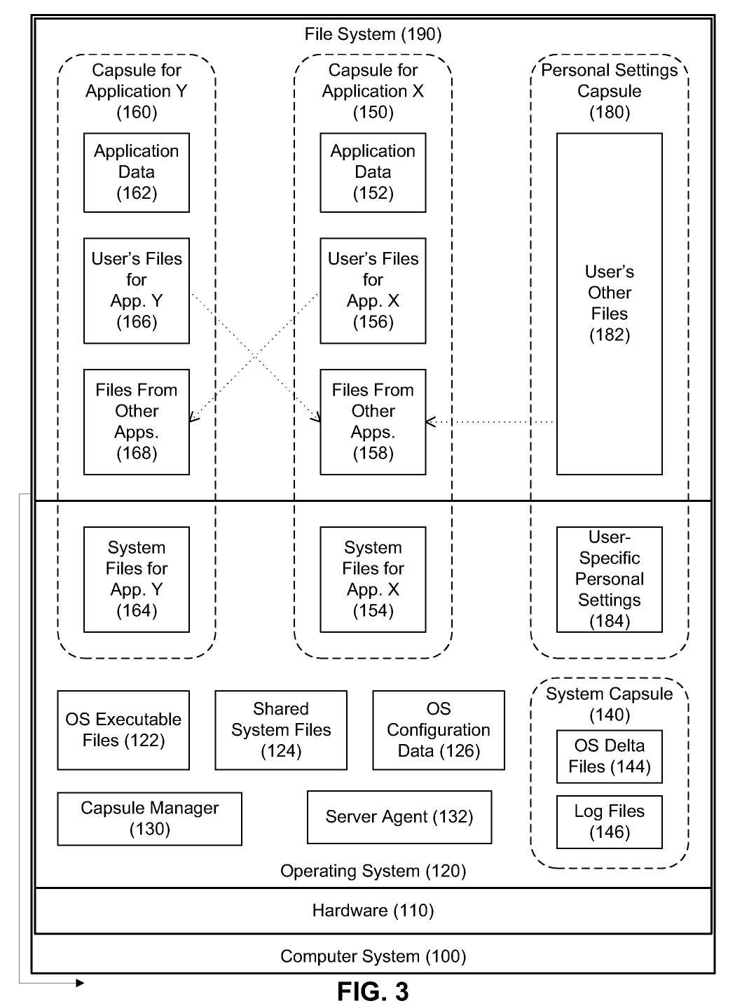

FIG. 1 shows a pool 710 of like pool members 711 in use by different users. All the pool members 711 are in communication with a particular server machine 712 (hereafter referred to as a “server”) through a computer network 713. The logical architecture for software associated with an individual pool member 711 and the manner of its configuration is discussed in connection with FIG. 3.

Tied to the server 712 is software the includes computer-executable instructions to cause it to communicate with an external data storage system 714 that stores both a baseline image 716 and user dossiers 718₁, 718₂, 718ₙ. Each user dossier 718ᵢ contains information concerning the configuration of a desktop computer 711 associated with a particular user U-i. Generally speaking, a server 712 can manage multiple pools 210, each of which has its own baseline image and corresponding pool members 711.

As used herein, the subscript “i’ as used in the figures is intended to refer to any one of the structures explicitly shown.

In general, each pool member 711 executes an image I1, I2, . . . In corresponding to the user U1, U2, . . . Un who is logged into it. The image can be stored and instantiated at the pool member 711 itself, as is the case for image I1 corresponding to user U1. Or, in the case where the pool member 711 includes a thin client component (or remote terminal component), the image can be stored on an external data storage system 714 and instantiated on the server 712, as is the case for images 12 and In.

In either case, an image I1, I2, . . . In is constructed “on the fly” on the basis of a baseline image 716 together with information stored in a user dossier 718₁ for a particular user U-i.

A user dossier 718₁ for a particular user U-i includes information for creating a virtual desktop for that user. This information is collected by a server agent 132 that is part of the baseline image 716. As a result, the server agent 132 is standard on every pool member 711 in the pool 710.

Upon detecting the beginning of an installation of a software package, such as a package preconfigured by an administrator to include selected applications, or a package containing user-specified applications, the server agent 132 identifies the package being installed. It then monitors the system for changes and records any such changes to the baseline image. These changes include new and deleted files, changes to existing applications and files, and changes to the user's personal settings.

When installing a software package on an MS-Windows based system, the server agent 132 monitors both the file system and the registry for any changes. As it does so, it creates metadata to summarize the changes made to both the file system and the registry. To carry out these functions, the server agent 132 typically includes a registry driver and a mini-filter file system driver.

Upon occurrence of a triggering event, the server agent 132 transmits the metadata back to the server 712. This causes the user's dossier 718₁ to be updated in the external data storage system 714 with information concerning newly installed applications, and/or information concerning personal end-user settings for the applications installed in the baseline image, data files related to such applications and OS personal settings like printers, favorites, desktop items, mapped drives, etc. In addition, any new files or registry information that have been deemed persistent are replicated at the external data storage system 714. In some cases, newly-installed software is also sent to the server 712 for inclusion in the baseline image 716.

A suitable triggering event for triggering metadata transmission is the end of a session, which is marked by a user logoff. However, other triggering events are possible. For example, the metadata transmission may occur at the conclusion of an installation, or at regular intervals within a session, upon exiting from an application, saving of a data file, or changing of the application/windows settings. In addition, a triggering event can result from manual intervention, for example by the pool member himself, or by a system administrator.

When the user U-i next logs into any one of the pool members 711 within the pool 710 (which may or may not be the same as the pool member that the user previously logged into), that user's dossier 718ᵢ is consulted. Based on information stored in the user's dossier 718ᵢ, the user's virtual desktop Iᵢ is executed or instantiated, and the user's previous changes to the image are incorporated, at least to the extent that any changes the user made are deemed persistent according to the policy.

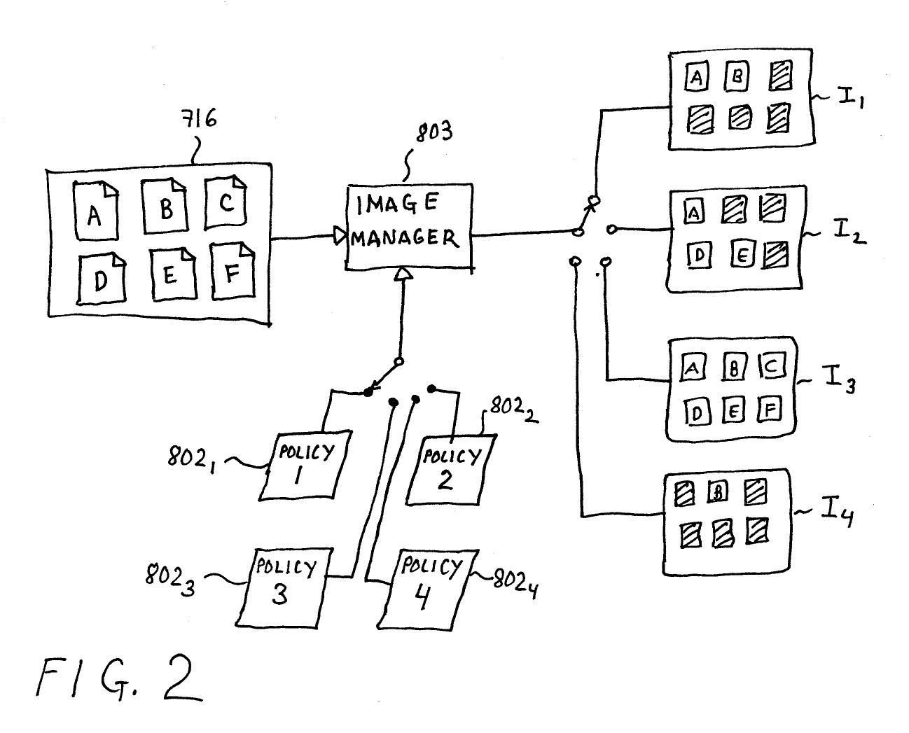

Referring to FIG. 2, in some cases, it may be desirable to control a user's image. For example, one may want to provide certain users with access to some, but not all, applications available on the baseline image 716. Or one may want to allow some but not all user-executed changes to be made persistent. Such control over both the accessibility of particular applications and persistency of changes is made on the basis of a user policy 802ᵢ associated with the user's identity.

User policies 802ᵢ are stored on the external data storage system 714 for implementation by an image manager 803 executing on the server 712. The image manager 803 can impose user policies 802ᵢ on users by identifying those applications and data that selected users or user groups are allowed to see, which ones are to be filtered, and what changes are permitted to be persistent. Conversely, the image manager 803 can impose user policies 802ᵢ on applications and/or data by identifying those users that are allowed to see particular applications and/or data.

In addition to having a personal dimension, a user policy 802ᵢ can also have temporal and/or spatial dimensions. For example, a user policy 802ᵢ may define times at which certain applications are not available to the user U-i. Or, a user policy may define personal OS settings to control which resources, such as printers, mapped drivers, and scanners, are available to a particular user and when those resources are available. Or, a user policy 802ᵢ may define locations from which certain applications and/or resources are not available to the user U-i. Additionally, a user policy 802ᵢ can have a network dimension. This includes cases in which the availability depends on some property of the network connection between the server 712 and the pool member 711. For example, a user policy 802ᵢ may deny access to one, some, or all selected resources and/or applications if the network connection lacks sufficient security.

To implement a user policy 802ᵢ, one can encapsulate selected applications and data, as discussed below in connection with FIG. 3 et seq., and then define those capsules that are to be made available to the particular user. Then, depending on the user's identity, the image manager 803 causes an appropriately masked image to be made available to that user, regardless of the particular pool member 711 that that user has logged into.

Upon a user's login at a particular pool member 711, the image manager 803 identifies the user policy 802ᵢ or policies relevant to that user and/or to the applications present on that pool member. The image manager 803 then provides those user policies 802ᵢ to the server agent 132 executing, or otherwise tied to, the particular pool member. The server agent 132 then causes the encapsulation system described herein to implement the identified polices by creating an appropriate masked image Iᵢ.

A difficulty associated with constantly adding software to the baseline image 716, followed by selectively concealing selected software from selected users, is that the baseline image 716 can grow large and unwieldy. This, in turn, tends to increase latency during the login procedure.

In an effort to circumvent this difficulty, certain implementations construct portions of the virtual desktop on an “on-demand basis.” In such implementations, data or software is included in the virtual desktop image only when the user actually requires that software or data. One way to implement this is to provide links between user filenames and actual files located at the external data storage system 714. As a result, the user who wishes to access a file can do so in the usual way, without having to know that the file is in fact located in the external data storage system 714. In response to a request for a file, the external data storage system 714 can stream the file to the user. Alternatively, the external data storage system can anticipate a user's need for a file and stream that file in the background, even before receiving an explicit request.

Once a user logs into any pool member 711 in the pool 710, regardless of that user's location, the capsule manager 130 automatically implements the user policies 802ᵢ for that user.

FIG. 3 shows an example pool member 100 from the pool 710 shown in FIG. 1. In an example pool member 100, an operating system 120 executing on hardware 110 manages the interactions between users, software, and hardware. A file system 190 hosted on the hardware provides an arrangement of data on the hardware for storing installed application files and user files associated with each user account. A typical operating system includes system applications 122, e.g., management utilities, administrative tools, and simple text and image editors; shared system files 124, e.g., hardware drivers; and operating system configuration data 125, e.g., settings stored in a registry.

In the exemplary pool member 100, the various constituent software elements can be instantiated in a single physical computer. Alternatively, for example where the pool member 100 is a thin client, there may exist virtual desktop infrastructure for instantiating one or more of the constituent software elements on a remote server, such as server 712 in FIG. 1. Thus, FIG. 3 is intended to be a logical representation of the architecture for software elements associated with an operating pool member 100 without implying the physical location for the instances of the software elements.

Example pool member 100 also includes a capsule manager 130 that creates and manages capsules. The capsule manager 130 manages a system capsule 140, an application capsule for each application or set of applications (e.g. a capsule for Application X 150 and a capsule for Application Y 150), and a personal settings capsule for each user (e.g., personal settings capsule 180), which is associated with that user's account.

The encapsulation scheme described herein, enables a user to log into any pool member 711 and re-create some or all of his environment as it existed the last time he logged into another pool member 711, regardless of that user's location. In effect, the encapsulation scheme described herein enables the user's computer to travel with him “on the cloud.” The extent to which a user's computer travels with him “on the cloud” depends on policies created by a system administrator. Depending on those policies, some aspects of the user's personal environment will be recreated, whereas other aspects may be omitted.

The capsule manager 130 creates capsules, manages the association between an application and its capsule, manages the interaction between applications, and provides additional features enabled by the use of encapsulation. The actions performed by a capsule manager 130 are generally transparent to applications. That is, each application is presented with a view of the file system and, if present, the registry, that is consistent with the ordinary view presented without a capsule manager 130. An application does not need to be modified or developed in a manner to accommodate the use of a capsule manager 130.

Encapsulating an application includes associating files and settings related to the application into associative capsules. An encapsulated file management system encapsulates and separates applications from the underlying operating system. Each application, or application group, is managed separately from the interaction between the operating system and other applications. Each capsule includes the application executable and any associated files. Some capsules include multiple application executable files (e.g. software suites), as appropriate for the application or application group. At the same time, the system allows and enables file sharing between different encapsulated (and/or non-encapsulated) applications. A file from a first capsule (or not in a capsule at all) that is modified by an application within a second capsule is encapsulated, in modified form, within the second capsule. This leaves the original version, found in the first capsule, unmodified within the first capsule. File versions are tracked by the capsule manager 130 so that, in some examples, subsequent use of a file is always from the most recent version, regardless of capsule.

The system capsule 140 encapsulates alterations to the original operating system installation, for example in the form of delta files 144, and operating system log files 145. The system capsule 140 may also encompass some types of system applications, while treating others as stand alone applications placed in capsules. For example, Microsoft® Corporation generally bundles a text editor (notepad.exe) with their operating systems.

In some embodiments, separate capsules are used to manage the activities of some bundled applications, for example, a notepad capsule for the Microsoft® bundled text editor. The personal settings capsule 180 manages user files 182. Such files 182 can include those not associated with an encapsulated application that is available to the user upon logging into his account. Such user-files include files copied into the system by the user, and user-specific operating system settings 184, e.g., printer configurations and display settings.

In effect, the capsule manager 130 can be used to cause certain users to see only certain selected applications. This enables the capsule manager 130 to define classes of users, each of which can access different applications.

In general, there is no guarantee that software and data necessary to reconstruct an image will be available on a particular computer. As a result, when location independent images are defined, as described above, it can become necessary to deliver selected software and other data quickly, to avoid latency during log-in. To reduce latency, the capsule manager 130 inspects metadata to determine if particular software or data is unavailable at the computer. If any such software or data is unavailable, the capsule manager 130 causes certain software and data to be provided to the computer on demand. This avoids the need to pre-install the data or software.

The foregoing methods, and systems for carrying out such methods, differ from corresponding methods and systems used in connection with de-duplication. In de-duplication systems, one searches for duplicate blocks. In contrast, the capsule manager 130 searches for duplicate applications.

In some cases, a user who is logged into his account can also use one application, e.g., Application X, to work with application files from another application, e.g., Application Y. In this case, any files 155 read by Application X remain in the Application Y capsule. Any files modified 158 by Application X are saved within the Application X Capsule 150. The original versions of these files are left unmodified, for example as Application Y user files 155. Because a file is only duplicated when modified, this is known as “copy-on-write.” Modifications in a copy-on-write strategy are either handled by first copying the file and then altering the copy, or where more efficient, by writing a new version of the file with the modifications, without needing to copy the file. Registry access within a particular user account is managed in the same manner as file access, with registry keys being duplicated as needed.

In some embodiments, capsule manager 130 intercepts each registry or file system request from each requesting process and replaces registry key and file paths in the request with registry keys and file paths from the encapsulated file system schema appropriate for the requesting application. The capsule manager 130 determines the correct capsule view for the requesting process and, as a function of the requested file or registry key, the requesting process, and the proper system view. The capsule manager 130 further determines the native file path or registry key for use in the substitution. The replacement request is passed to the operating system 120 or storage hardware 110. The request response can then be sent to the originating process. In some implementations, requests are intercepted using a kernel level driver. In other implementations, the request-response passes through the capsule manager 130. In yet other implementations, the capsule manager 130 interacts directly with the hardware 110, without using the operating system 120.

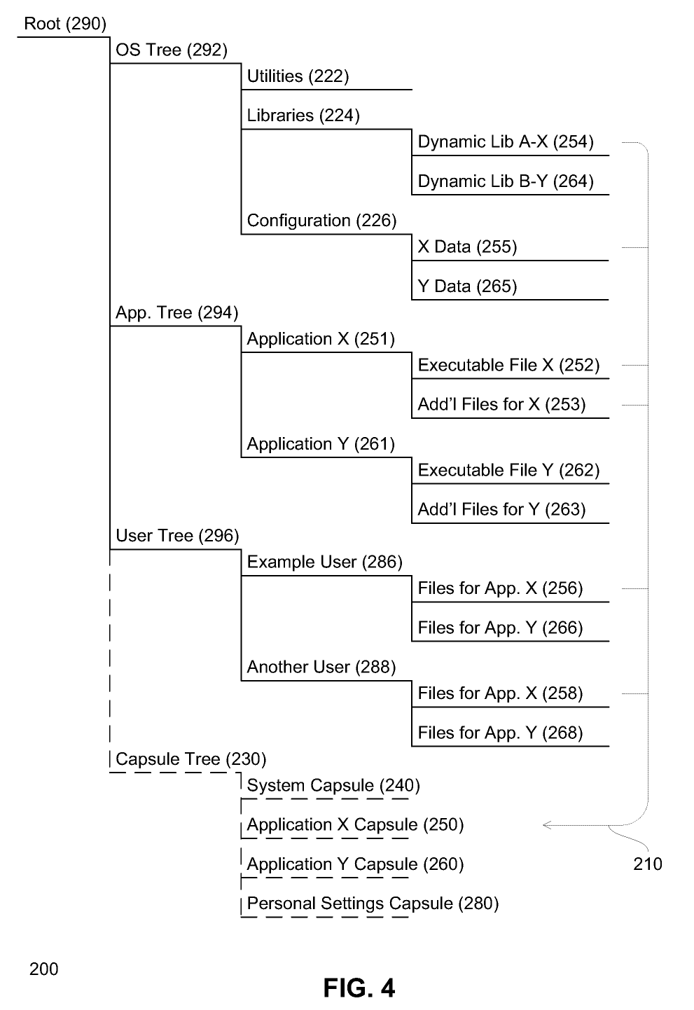

Referring to FIG. 4, a typical operating system file system schema on a single volume 200 starts with a root 290, for example “C:\”. There are a number of directories in the root grouping together related sub-directories. A typical configuration includes an operating system tree 292, for example “C:\WINDOWS\” and one or more application trees 294, for example “C:\Program Files\”. Most operating systems include additional software, for example configuration utilities, system monitors, and other rudimentary applications. This software is typically collected into a “bin” directory or spread into several directories, for example split between the OS Tree 292 and the Application Tree 294. In the present example, this additional software is collected together in the OS Tree 292 in the Utilities directory 222. Also present in the OS Tree 292 is a directory for additional libraries 224, e.g., DLLs, and a directory for configuration data 225. Some systems also include a user file tree 295, for example “C:\Documents and Settings\”. Systems supporting multiple users typically include directories in the user file tree for each user, for example a user 285 and another user 288.

When an application is installed in a system without a capsule manager 130, the installation process typically creates a directory in the application tree 294 and adds files to folders in the OS tree 292, for example adding additional DLLs to the libraries directory 224. In some cases an installation also adds files, or a special sub-directory, to each user account's file tree. For example, installation of Application X expands the application tree 294 by adding an Application X directory 251 containing an executable file 252 and additional application files 253. Installation of Application X also adds a DLL 254 in the libraries directory 224, configuration data 255 in the configuration directory 225, and user files in each user directory (shown as files 255 under primary example user 285 and files 258 under another user 288). These files would generally be available to any user logged into any user account.

Each subsequent installation of an application further grows the directory structure and adds files to directories in the OS Tree 292. For example, installation of Application Y expands the application tree 294 by adding an Application Y directory 251 containing an executable file 252 and additional application files 253. Installation of Application Y also adds a DLL 254 in the libraries directory 224, configuration data 255 in the configuration directory 225, and user files in each user directory (shown as files 255 under primary example user 285 and files 258 under another user 288).

When an application is installed in a system with a capsule manager 130, the native directory structure remains as a view of the file system for processes invoked by the user. However, the capsule manager 130 intercepts each file system request. Upon doing so, the capsule manager 130 journals the request so that any file access operations are carried out on data stored in external data storage system 714. Alternatively, the capsule manager 130 replaces paths and file locations in the request with paths and file locations from the encapsulated file system schema appropriate for the requesting application, as described above. The rerouting is managed by capsule manager 130, which presents a capsule-specific file system view to each application (including, for example, a user shell), such as that which would be seen by a user upon logging into his account. As explained below, there are two types of capsules, for purposes of determining a view: isolated and general capsules. An application in an isolated capsule only has a view of files stored within the capsule and the most recent versions of files not within the isolated capsule. An application in a general capsule has a unified view of the most recent version of every file not within an isolated capsule. An application not managed in a capsule is presented the same unified view as if the application were in a general capsule. The view is translated to the capsule schema, locating files in the underlying native file system, by the capsule manager 130.

In some implementations, the capsule manager 130 creates a capsule tree 230 to serve as a root for the capsule schema. Modifications made to the operating system and/or made using the software in Utilities directory 222 are captured in system capsule 240. All files created or related to an application are located in the capsule associated with the application. For example, installation of Application X creates an Application X Capsule 250. Access to a file stored in Application Tree\Application X 251 is rerouted 210 to instead access a file in the Application X Capsule 250. Additionally, operating system configurations, on a user level, are stored in personal settings capsule 280. Where configuration data is stored in a registry not accessible via the file system, registry access is managed in the same manner using a special capsule tree of registry entries.

Other embodiments and implementations store capsule contents and data in other formats. For example, in an alternative implementation, instead of using special directories, data is located in databases. In another example, special archive files are used. In some implementations, the capsule manager 130 uses a journaling approach to file management. In a journaling approach, the capsule manager 130 uses the native directory schema in combination with capsule journals. Capsule journals can be maintained either at a local machine, or at a server that maintains a baseline image for plural local machines. References for files in a capsule are recorded in a journal maintained for the capsule. Where a filename in one capsule conflicts with a filename in another capsule, the capsule manager 130 supplies a pseudonym for one or both files. For example, a file “sample.dat” modified by Application X might be named “sample.dat.Capsule_X”. A subsequent modification by Application Y might be named “sample.dat.Capsule_Y”. In some examples, versioning information is also incorporated into the filename. Where configuration data is stored in a registry not accessible via the file system, registry access is managed in the same manner using capsule named registry entries.

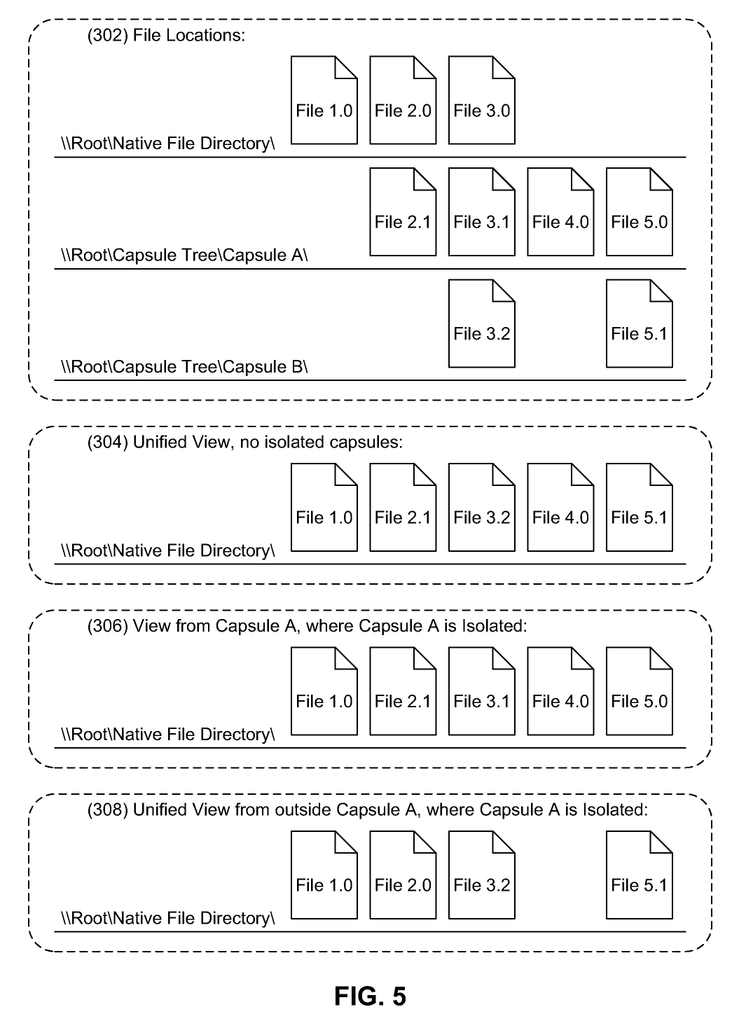

Referring to FIG. 5, in some implementations, different versions of the same file are stored in different locations. Five example files are sufficient to demonstrate file view perspectives, using three file locations 302. In an un-encapsulated directory there are original file versions for File 1.0, File 2.0, and File 3.0, where “File N.M” is shorthand for “File N, Version M”. In a capsule directory for capsule A, there are original file versions for File 4.0 and File 5.0, along with modified file versions File 2.1 and File 3.1. In a capsule directory for capsule B, there are modified file versions File 3.2 and File 5.1. A unified view 304 of these files, showing the most recent version of each file, includes File 1.0, File 2.1, File 3.2, File 4.0, and File 5.1.

An isolated capsule has a view of files stored within the capsule, and only the most recent versions of files that do not have a version stored within the capsule. For example, the view from capsule A, where capsule A is isolated 306, includes File 1.0, File 2.1, File 3.1, File 4.0, and File 5.0. An isolated capsule can thus be used to encapsulate applications that, according to a particular user policy 802ᵢ, are to be made accessible only from that particular user's account, while concealing those applications that are not intended to be available from that user account.

A general capsule has a unified view across all general capsules and un-encapsulated files, encompassing the most recent version of every file not within an isolated capsule. For example, the unified view from outside of capsule A, where capsule A is isolated 308, includes File 1.0, File 2.0, File 3.2, and File 5.1. File 2.0 is included, instead of File 2.1 stored in isolated capsule A, because File 2.0 is the latest version not stored in an isolated capsule. Likewise, File 4.0, stored only in isolated capsule A, is not included because no version of the file exists outside of an isolated capsule. A general capsule, for example Capsule B, has a unified view. All general capsules have the same view. General capsules are thus suitable for encapsulating applications that are intended to be accessible from all user accounts.

Access by an application within a capsule to a file outside of the capsule does not alter the external file. Each capsule uses a localized copy for modified files. In some embodiments, when an application with a capsule opens a file for write access and the file is not present within the capsule, the file is first copied into the capsule. This intra-capsular copy is then opened for modification. In some cases it is more efficient to write a new file in the capsule, rather than copying a file. For example, a new file is written where an entire file would be overwritten. Registry access is handled in the same manner. All file or registry changes are maintained within the capsule. Note, however, that operating system files and memory management files (e.g., page files) reside in the operating system capsule.

For a file being opened for read-only access, the version available within the capsule view is opened. As a result, while multiple versions might exist within the file system, each version associated with the same file path, the previously explained view system only reveals, and opens for reading, the most recent version.

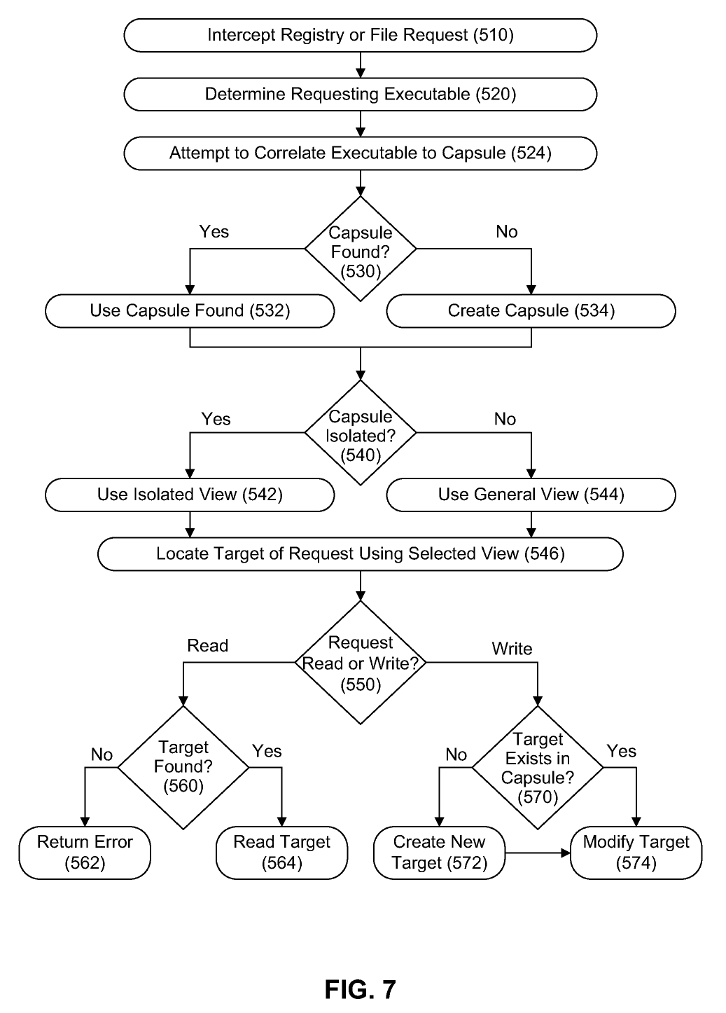

Referring to FIG. 7, the process of resolving a registry access or file system request begins by intercepting the request 510. The requesting executable file is then determined 520. This can be done, for example, using the Window's PSAPI.DLL function GetProcessImageFileName( ). If the application is encapsulated, the executable path will indicate the capsule 524. If a capsule is found 530, then that capsule is used to resolve the request 532. If no capsule is not found, a capsule is created 534.

The requesting application's capsule determines the view used by the application executable file. If the capsule is isolated 540, an isolated view is used 542. Otherwise a general unified view is used 544. The difference between views is discussed above. Using the appropriate view, the target of the request is located 545. The result of the search is processed based on whether the request 550 is a read request or a write request. If the request is a read request, or a non-modifying request, processing depends on finding the target 560. If the target is not found, an error is returned 562. If the target is found, it is used to satisfy the request, i.e., the target is read 564.

If the request is a write request, or a modifying request, processing depends on the target's capsule status 570. If the target does not exist in the capsule, a target is created in the capsule 572. The target within the capsule is then modified according to the request 574. In some cases, the target is created 572 by duplicating a target from outside the capsule. This might be done, for example, upon a request to modify an element in a database. In other cases, it is not necessary to duplicate the target, for example if the modification is going to rewrite the target. In this scenario, creating the target means creating a new file or registry key.

When an instruction to delete a file having no other versions is received, the file is deleted. If other versions exist, some special treatment is used to maintain a record of the file deletion. In that case, the deletion is treated as a modification localized to the capsule. For example, a deleted file record is kept within the capsule. Since the record is the most recent version of the file, it will effectively be deleted from the system's name space. In some embodiments, the file's last version is not actually deleted. In a similar case, where multiple versions of a file exist and the file is renamed by a capsule, the file's old name version is marked as deleted and a new version of the file with the new name is created. Registry modifications are handled in the same manner.

The file system view presented by the capsule manager 130 does not include capsules that have been deactivated or deleted. Deactivating a capsule is not the same as deleting it. When a capsule is deactivated, the resident data remains, but the capsule ceases to participate in the file system. When a capsule is deactivated, all processes running executable files from within the capsule are terminated and the files become invisible to file system views, just as if the capsule were isolated. However, the capsule contents remain in storage and can later be reactivated. In some implementations, capsules are activated and deactivated based on an automated trigger. For example, an administrator might configure a computer system such that certain application capsules are only available at certain times, e.g. deactivating capsules for applications that use a large amount of network bandwidth during business hours. Or, for example, sensitive capsules stored on a particular machine may be activated only when that machine is connected to a secured corporate data network. In a similar way, the user-specific user policies 802ᵢ discussed in connection with FIG. 2 can also include a temporal component that could be enforced as described above.

When a capsule is deleted, the capsule content is also deleted. Any application in the capsule is deleted along with all the application files, configuration data, and anything else contained in the capsule. In some implementations, before deleting the contents of the capsule, some files (e.g., user files) are copied to another capsule or to the native file system at the files' view-apparent locations. Merging the files in this manner reduces the data lost when deleting a capsule.

To delete a capsule without deleting its contents, i.e. to un-encapsulate an application, all of the files in the capsule are merged into another capsule or into the native file system so that only an empty capsule is deleted. Effectively, the capsule is deleted but the capsule content is moved to its native location, just as if the application had been installed and used on the computer without encapsulation.

Within each capsule, each file is associated with a native file system address. Separate capsules may contain files mapping to the same external address, as seen in the different file versions shown in FIG. 5 and discussed above. Similarly, in some implementations, one capsule may contain multiple file versions mapping to the same address. Triggering events render the contents of a capsule read-only such that future write attempts within the capsule are directed to a new location within the capsule. In some implementations, modifications to a read-only file are saved as file chunks with an appropriate map-file (e.g., modifications to parts of a large database file). Example triggers include: system restart; instantiation of an application; modification of a file within a capsule if the previous version of the file was created outside of the capsule; a scheduled event; installation completion; capsule import or export (disclosed in more detail below); or merger with another capsule.

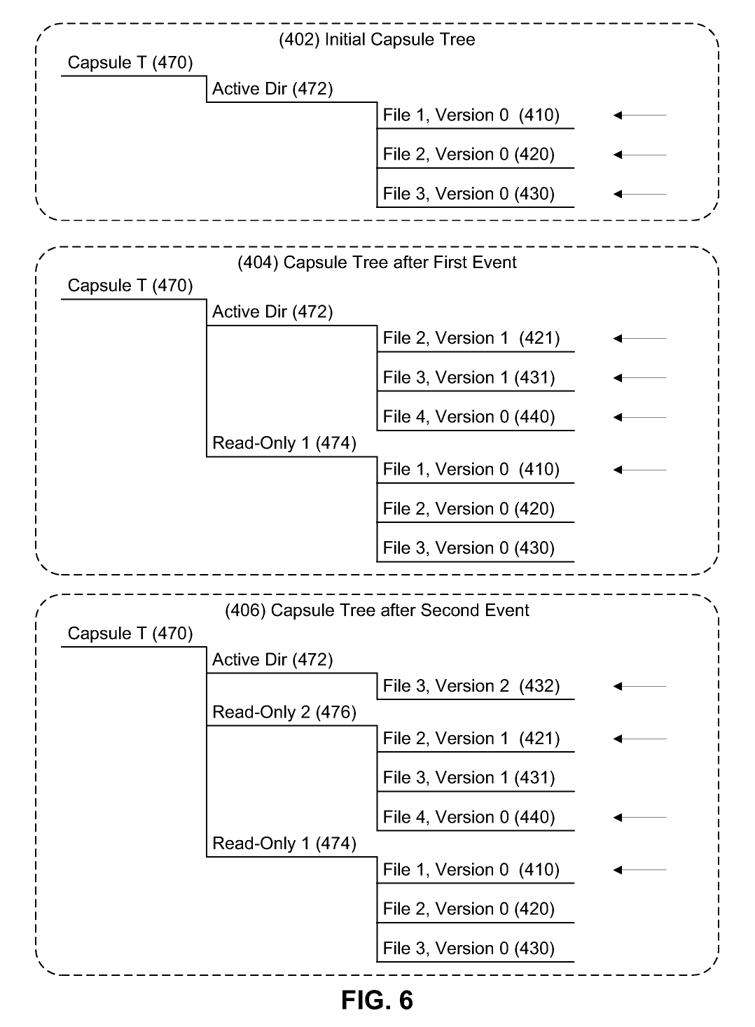

Referring to FIG. 6, in one example, multiple sub-directories within the capsule are used to separate read-only files, with one directory being designated for write-activity and the others being designated for read-only prior versions of the capsule. An initial capsule tree 402 with root Capsule T 470 has an active directory 472 containing writeable files, for example File 1 410, File 2 420, and File 3 430. These files are the files visible to applications, as indicated by arrows.

A triggering event causes the write-activity directory to become read-only, and also causes a new directory to be established for future write-activity. For example, the capsule tree after a first event 404 has a read-only directory 474 containing the original versions of the files previously in the active directory 472. The active directory 472 contains any modifications of these files, for example File 2 421 and File 3 431, and any new files, for example File 4 440. A view of the capsule still shows the most recent version of each file, regardless of its sub-directory, as indicated by arrows.

The foregoing process can be repeated. For example, the capsule tree after a second event 406 has the prior read-only directory 474 and a new read-only directory 476 containing the versions of the files that were previously in the active directory 472. The active directory 472 contains any file modifications, for example File 3 432, and any new files. A view of the capsule still shows the most recent version of each file, regardless of its sub-directory, as indicated by arrows.

A capsule can be rolled back to the time of any trigger event. In one implementation incorporating the described sub-directory approach, read-only and active directories populated after the target trigger event are excluded from the capsule view. A system administrator can thus roll back and forth through a capsule's history by excluding and/or including directories. A new active directory is used for modifications going forward.

In some implementations, operating system modifications and configurations are separated from user files, for example, the operating system uses a registry. In these implementations, each capsule incorporates a registry tree for the capsule. Registry trees contain key/value pairs for use within the capsule. This data is managed in the same manner as with files, including the ability to create read-only sets of keys and the ability to rollback. In some implementations the rollback within the registry is separated from the rollback of the user files. This allows one rollback to be done with or without the other. In some implementations application configuration is managed distinctly from application data, where configuration may include a mixture of registry entries and configuration files. In these implementations rollback of configuration can be handled separately from rollback of data.

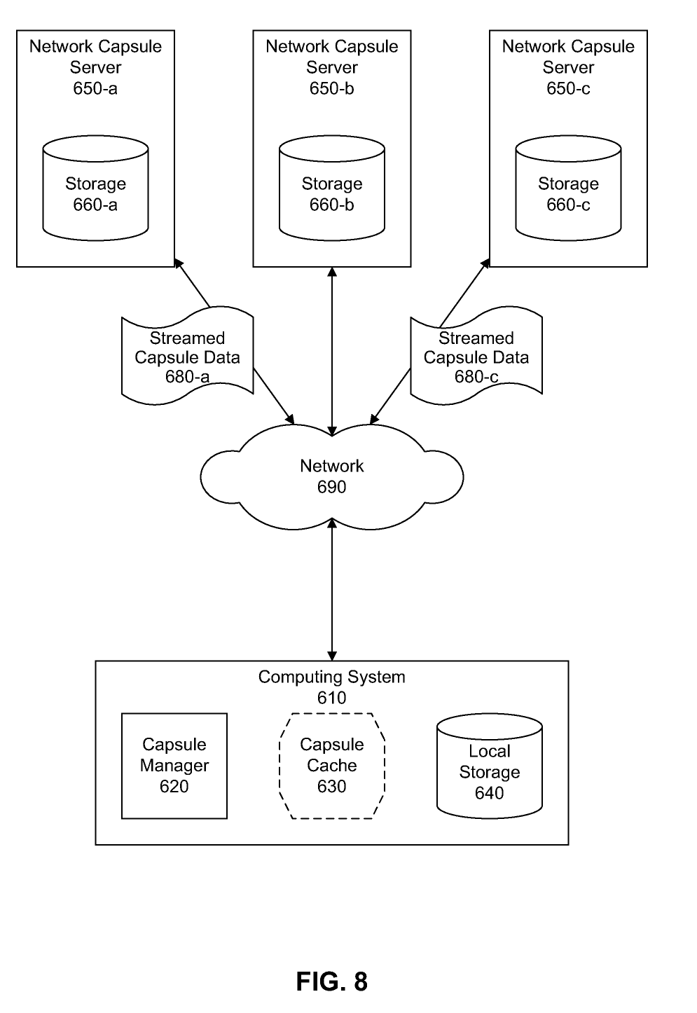

In some implementations, each capsule contains all of the elements for an associated application and makes no external modification to the operating system. An encapsulated application can be cleanly and completely removed from a system. Deleting a capsule, as described above, completely removes all of the files, and if applicable, registry entries, within the capsule. This includes all changes that an application within the capsule caused to a file system and/or registry. Likewise, restoring the capsule completely restores the application. A back-up copy of a capsule can be used to restore every element of the capsule, including settings, executable files, and data files. This can also be used to deploy copies of an application to multiple computer systems by copying the application capsule. For example, with reference to FIG. 1, copies of an application can be deployed among all pool members 711 in a pool 710 by copying an appropriate application capsule stored on the external data storage system 714. This procedure is described in more detail below in connection with FIG. 8.

Different versions of an application can co-exist on a single computer system, each within its own capsule. For example, a first version of an application within an isolated capsule is invisible to a second version of the application in a separate capsule. Or in another example, a first version of an application within a deactivated capsule is invisible to a second version of the application in a separate capsule. A system administrator can thus test a new installation without having to remove the previous installation. User files from the multiple capsules can later be merged.

In some cases, an application installation can be moved, along with its associated configuration data and user files, from one computer to another by copying the capsule. The encapsulated application can be transferred by, and used from, network drives, USB drives, or any other portable medium, or from an external data storage system 714 accessed via a network 713, as shown in FIG. 1. Capsules can be streamed to or from a data server connected via a data network, for example, the Internet. In some implementations, the capsule manager 130 does not download the entire capsule. Instead, the manager downloads portions of the capsule as needed, for example, when those portions are accessed. Applications can be migrated together with application settings and user data without the need to run an application installation utility on each capsule-enabled system.

Referring to FIG. 8, an example computing system 610 equipped with a network capsule manager 620 exchanges capsule data 680a with a network capsule server 650a to which it is connected via a data network 690. The capsule server 650a hosts capsule data on storage 660a accessible to the capsule server 650a. A capsule manager 620 installed on computing system 610 streams capsule data 680a to and from the network capsule server 650a.

Capsule data 680a contains one or more complete capsules or portions of capsules. Any kind of capsule can be streamed, including operating system capsules and user specific capsules. A user of a computer 510 with a network capsule manager 620 can stream an application from a network capsule server 650a, use the application locally in the computer 610, and upload modifications to the capsule back to the network capsule server 650a, for example sending back user file modifications. In some implementations, an administrator is able to modify capsules stored on network storage 660a, for example, enabling an administrator to update application software, install patches, or to implement user policies 802ᵢ.

In some implementations, the network capsule manager 620 uses a capsule cache 630 to reduce network usage. Only updates to a streamed capsule are streamed on subsequent uses. In some implementations updates or missing portions of a capsule are only streamed as needed. The capsule cache 630 and associated capsule data are stored in storage 640 local to the computing system 610. In some implementations, an application uses two capsules, one for the relatively constant application data (e.g. the executable and its associated libraries) and a second capsule for more frequently altered data (e.g. user files).

In some implementations, multiple capsule servers 650a-c are used, for example, one server 650a may be designated for serving operating system capsules (which may be read-only), another server 650b may be designated for application capsules (which may be read-only), and a third server 650c may be designated for user capsules (which may support uploading modifications). Using multiple capsule servers a computing system 610 can exchange capsule data 680a with a first capsule server 650a and also exchange other capsule data 580-c with the third capsule server 650c.

Using a networked approach to capsule distribution, multiple computers can present the same or similar computing environments to a user. For example, a computer user in an office setting using capsules can also transfer capsules to a second computer, e.g., a home computer. The capsules can be transferred by a portable medium (e.g., a portable memory card), over a network (e.g., the Internet), or in any other available manner. Entire capsules can be transferred or only portions of a capsule can be transferred.

In some embodiments, one or more capsule servers host operating system capsules, personal settings capsules, and application capsules. A user boots a local computer system which then transfers one or more operating system capsules from a capsule server. These operating system capsules are then used as the operating system for the local computer system. Personal settings and applications are also transferred from a server and used locally. In some implementations, capsules modified in the local computer system are transferred back to the host. In some implementations, alterations are synchronized to resolve alteration conflicts between multiple instances of a capsule. Synchronization can occur, for example, at the beginning or end of a user session. In some implementations, the local system is only a thin client and images (e.g., screen images) are streamed from the servers only as needed. For example, the operating system itself can be streamed from a server. In some embodiments using the streaming approach, a full operating system is also resident in the local computer to support off-line work. Synchronization of user capsules is performed once the machine is re-introduced to the network.

In some implementations, a computer system can be converted from a system with applications installed without capsules to an encapsulated system, each application in an associated capsule. In one example, when the capsule manager is installed, it can enumerate and analyze all the previously installed applications present, for example by analysis of MSI (Windows Installer, also known as Microsoft Installer or Darwin) installation records. Based on this analysis, the capsule manager 130 can compose, for each application, a list of files and registry values which were created/updated during installation. Application encapsulation can be performed according to this list. However, MSI records are not always complete; for example, files/registry values updated at application run-time (as opposed to install-time) will not be included. In some embodiments, conversion to an encapsulated system does not move pre-existing files or registry entries. Rather, the pre-existing application files and registry entries are associated with new capsules and the capsules only contain files and registry entries created or modified after the encapsulation.

In another example, the capsule manager can simulate the process of application un-installation without actually changing the native file system or registry. For example, a module capable of capturing file and registry requests (e.g. part of the capsule manager) captures the un-installers requests and simulates the correct responses for un-installation. A list of files/registry values requested during this process serves as a basis for application encapsulation. The process is untraceable by the user as installation dialogs are kept invisible and installer logs are cleaned up. The resulting capsule includes all files and registry settings that would have been removed by the uninstaller.

In another example, where pre-installed applications are well known, the capsule manager uses a knowledge base to determine the files and registry settings to be included in a capsule. This approach takes into consideration the environment of the computer system, for example operating system, service pack or patch level, and dependencies on other applications. The knowledge base can include configuration units known to be updated at application run-time.

In another example, where the Operating System is encapsulated, there are three spaces each populated with one or more capsules: an operating system space; an application space; and a user space. A computing environment is created by selecting one or more capsules from each space. In some implementations, the operating system capsule and/or application capsules are streamed from one computer to another. The streamed capsules are treated as read-only, restricting user modifications to user capsules. In some cases, user capsules are also streamed from one computer to another, for example, storing user capsules on a data server accessible from other computer systems. Maintenance and modification of the operating system capsules and/or application capsules is performed on the stream source, thereby simplifying patching or upgrading. The implementation of such a system can be done in a variety of ways, including implementation based on VMware, based on the driver which will deliver to the desktops separate images of the Operating System.

In another example, a system may be configured with multiple modes. For example, a laptop computer is set up with two modes, one for use “at work” and another for use “at home.” The “at work” mode deactivates the capsules supporting non-business applications (e.g., games) and activates work applications (e.g., software for accessing the corporate network). The “at home” mode reverses the activations, enabling the non-business applications and disabling work-specific applications (e.g., preventing unauthorized access to the corporate network). In some examples, the modes may be activated/deactivated remotely by an administrator. In other examples, one or more capsules may be individually enabled or disabled through a remote action taken by an administrator. These are examples of implementing a user policy having a temporal dimension as discussed above.

For example, the system may be portable (e.g., a laptop or notebook computer) and configured with a listing of authorized business capsules. When the portable system is connected to a corporate network (e.g., when it is logged into a virtual private network, VPN), only the authorized business capsules are activated. When the portable system is not connected to the corporate network, the user can activate other capsules that may have been deactivated while the portable system was on the corporate network. In this way, a person using a corporate laptop might install an application while disconnected (e.g., while at home or at a conference), but the system operates as though the unauthorized application was never installed while the system is connected to the corporate network. Unauthorized applications can also easily be removed by deleting the unauthorized application capsule. These are examples of implementing a user policy with a network dimension as described above.

In another example, a computer system may be configured to prevent the user from modifying the environment settings, for example, by placing the operating system and/or its configuration in one or more read-only capsules. An application expecting administrative rights to a computer, including the ability to alter the operating system or its configuration, is placed in a capsule with a localized view of the operating system. Modifications made within the capsule are not reflected outside of the capsule, and can be undone by reverting to an earlier snapshot, e.g., an initial preferred state snapshot or a “baseline state.” In some implementations, the application has administrative permissions, but the application's ability to modify the system is constrained. In some implementations, the capsule always reverts to the baseline state at the beginning or ending of each usage.

The capsule manager may be implemented to be crash resistant. For example, the capsule manager may maintain a journal of capsule activity through the use of file system checkpoints. After a failure, the system can be rolled back to a previous checkpoint (e.g., the most recent checkpoint), placing the system in a known stable state, or in-progress transactions can be completed. In implementations where the capsule manager communicates with a networked capsule host, the journaling can also include network activity. This ensures that only completed capsule changes impact the system and simplifies crash recovery.

At times in this description, applications are described as making requests that are intercepted by the capsule manager 130. It should be understood that in some instances, a request intercepted by the capsule manager is generated by a process of an executable whose executable file is associated with encapsulated application. The capsule manager 130 may be implemented to resolve the process identification number (PID) of a requesting process to a capsule identifier based on a series of mappings (e.g., PID to executable, executable to application, and application to capsule).

The techniques described herein can be implemented in digital electronic circuitry, or in computer hardware, firmware, software, or in combinations of them. The techniques can be implemented as a computer-executable instructions tangibly embodied in an information carrier, e.g., in a machine-readable storage device (such as magnetic disk or tape, or optical disk) or computer-readable medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to, tied to, or be executed by one particular computer or on multiple particular computers at one site or distributed across multiple particular computers at multiple sites and interconnected by a communication network.

It will be appreciated that execution of computer-readable instructions results in real and tangible changes to memory locations in the computer. These changes involve movement of charge and current, and the resultant distortion and changes to electromagnetic fields in the vicinity of the device. Such changes can be measured by suitable measurement equipment including oscilloscopes, field probes, and voltmeters. In some cases, a computer executing software instructions as described herein can cause electromagnetic interference with nearby devices and also heat surrounding areas. Such changes all represent tangible and measurable transformation of matter.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. A computer-implemented method for causing a computer system to provide virtual desktop images to users of pool members, said method comprising:
receiving, from a user, a request to log into a first pool member from a pool;
retrieving a virtual desktop image for use by said first pool member;
inspecting a user policy;
modifying said virtual desktop image consistently with said user policy; and
providing said virtual desktop to said first pool member;

2. The method of claim 1, further comprising
receiving, from said user, a request to log into a second pool member, said second pool member being different from said first pool member;
retrieving said virtual desktop image for use by said second pool member;
inspecting said user policy;
modifying said virtual desktop consistently with said user policy; and
providing said virtual desktop to said second pool member.

3. The method of claim 1, wherein modifying said virtual desktop comprises denying said user access to an application on the basis of a user's identity.

4. The method of claim 1, wherein modifying said virtual desktop comprises denying said user access to an application on the basis of a time of log-in.

5. The method of claim 1, wherein modifying said virtual desktop comprises denying said user access to an application on the basis of a location from which log-in is attempted.

6. The method of claim 1, wherein modifying said virtual desktop comprises incorporating selected changes made by said user in a preceding session on a pool member.

7. The method of claim 1, wherein modifying said virtual desktop comprises incorporating selected changes made by said user in a preceding session on a pool member that differs from said first pool member.

8. The method of claim 1, wherein modifying said virtual desktop comprises implementing a persistency policy in which certain user changes are deemed persistent and certain other user changes are deemed non-persistent.

9. The method of claim 1, further comprising storing, at a remote data storage system, a plurality of user dossiers, each of which includes metadata representative of configuration changes made by a user to a virtual desktop image.

10. The method of claim 1, wherein modifying said virtual desktop image comprises encapsulating selected applications available in said image.

11. A manufacture comprising a computer-implemented medium having encoded thereon software for causing a computer system to provide virtual desktop images to users of pool members, said software including computer-executable instructions for:
receiving, from a user, a request to log into a first pool member from a pool;
retrieving a virtual desktop image for use by said first pool member;
inspecting a user policy;
modifying said virtual desktop image consistently with said user policy; and
providing said virtual desktop to said first pool member.

12. The manufacture of claim 11, wherein the software further comprises instructions for:
receiving, from said user, a request to log into a second pool member, said second pool member being different from said first pool member;
retrieving said virtual desktop image for use by said second pool member;
inspecting said user policy;
modifying said virtual desktop consistently with said user policy; and
providing said virtual desktop to said second pool member.

13. The manufacture of claim 11, wherein the instructions for modifying said virtual desktop comprise instructions for denying said user access to an application on the basis of a user's identity.

14. The manufacture of claim 11, wherein the instructions for modifying said virtual desktop comprise instructions for denying said user access to an application on the basis of a time of log-in.

15. The manufacture of claim 11, wherein the instructions for modifying modifying said virtual desktop comprise instructions for denying said user access to an application on the basis of a location from which log-in is attempted.

16. The manufacture of claim 11, wherein the instructions for modifying said virtual desktop comprise instructions for incorporating selected changes made by said user in a preceding session on a pool member.

17. The manufacture of claim 11, wherein the instructions for modifying said virtual desktop comprise instructions for incorporating selected changes made by said user in a preceding session on a pool member that differs from said first pool member.

18. The manufacture of claim 11, wherein the instructions for modifying said virtual desktop comprise instructions for implementing a persistency policy in which certain user changes are deemed persistent and certain other user changes are deemed non-persistent.

19. The manufacture of claim 11, wherein the software further comprises instructions for: storing, at a remote data storage system, a plurality of user dossiers, each of which includes metadata representative of configuration changes made by a user to a virtual desktop image.

20. The manufacture of claim 11, wherein the instructions for modifying said virtual desktop image comprise instructions for encapsulating selected applications available in said image.

21. A system for providing virtual desktop images to users of pool members from a pool, said method comprising:
a server subsystem in data communication with a plurality of pool members, said server subsystem having at least one processor, and a memory element operatively coupled to said processor, said subsystem being configured
to receive, from a user, a request to log into a first pool member from a pool;
to retrieve a virtual desktop image for use by said first pool member;
to inspect a user policy corresponding to said user;
to modify said virtual desktop image consistently with said user policy; and
to provide said virtual desktop to said first pool member.
